(19) United States
(12) Patent Application Publication
(10) Pub. No.: US 2012/0117195 A1
(43) Pub. Date: May 10, 2012

(54) System for Generating one or more Citation Forms from a Single Workflow

(75) Inventors: Jeremy Keith MATTERN, Austin, TX (US); Richard EZZEDDINE, Houston, TX (US)

(73) Assignee: IBERON, LLC, Houston, TX (US)

(21) Appl. No.: 12/940,530

(22) Filed: Nov. 5, 2010

(51) Int. Cl. G06F 15/16; G06F 17/00

(52) U.S. Cl. 709/219; 715/222

(57) ABSTRACT

A system and method for generating one or more citation forms from a single workflow is disclosed. Specifically, the method can include requesting determinative data within a workflow and assigning one or more citation forms based upon said determinative data.

### BACKGROUND

This disclosure relates to a system and method for electronic citation issuance and citation adjudication. More particularly, this disclosure relates to generating one or more citation forms from a single workflow.

For code infractions, authorities can issue citations to alleged offenders. For example, a civilian police officer might issue a citation to a motorist if the officer sees the motorist failing to stop at a stop sign. On federal and military installations, similar citations can be issued. Further, citations can be issued on different forms depending on the classification of violator and classification of vehicle. As an example, a citation can be issued on an Armed Forces Traffic Ticket form, (such as a DD form 1408), or equivalent, for all military or federal personnel or any civilian using a military or federal vehicle, for minor infractions such as talking on a cellular phone while driving, speeding, or failing to stop at a stop sign. As another example, a citation can be issued on a United States District Court Violation Notice form for non-military as well as military personnel.

Commanding officers and civilian supervisors (hereinafter referred to as “Supervisor”) are the deciding authority on Armed Forces Traffic Tickets, not a Federal Magistrate. Once the Supervisor has rendered a decision, the Supervisor communicates his decision with records personnel for record keeping and enforcement. Penalties from Armed Forces Traffic Tickets are assessed by Supervisors, which can include traffic points, and suspended driving privileges.

Present citation methods include citation officers stopping violators and filling out violation information on a carbon paper citation. One copy of the paper citation is delivered to the violator's Supervisor, a second copy is given to the violator, and a third copy is kept by the officer. The Supervisor can then review the citation and, after making proper notations on the citation regarding the manner of the dispositions, can deliver a copy to the records personnel.

However, there are a number of problems associated with paper citations. First, officer handwriting can often be illegible. Second, if a paper citation must go to many people, either a copy must be made for each person, or a shared copy must be sent to each person. Third, carbon copies are often difficult to read if the officer does not write with sufficient force. Fourth, paper copies can be lost, either in delivery or by the recipient. Last, notes typically cannot be added later to paper citations.

Another issue with paper citations written on federal or military installations is that currently, there is not a way to give a warning on some citation forms, such as the United States District Court Violation Notice form. As such, a federal or military citation officer wishing to issue a series of citations with at least one warning must fill out separate Armed Forces Traffic Ticket forms and United States District Court Violation Notice forms.

Last, another issue with citations issued on United States District Court Violation Notice forms is the inability to include multiple violations on a single citation.

It would, therefore, be advantageous to implement an improved method and system for creating, processing, and storing citations.

### SUMMARY

A method for generating one or more citations from a single workflow is disclosed. The method can include requesting determinative data within a workflow and assigning one or more citation types based upon said determinative data.

A system for generating one or more citations from a single workflow is disclosed. The system can include a mobile citation device that requests and receives determinative data within a workflow, and requests non-determinative data relating to one or more citations based upon said determinative data.

Last, a computer usable medium having a computer readable program code embodied therein is disclosed. The computer readable program code is adapted to be executed to implement the method mentioned above.

### BRIEF DESCRIPTION OF THE DRAWINGS

FIG. 1 illustrates a citation management system.

FIG. 2 illustrates input and output hardware on a mobile citation device.

FIG. 3 illustrates internal hardware within a mobile citation device.

FIG. 4 illustrates a memory map.

FIG. 5 illustrates a screen shot of mobile citation device.

FIG. 6 illustrates data.

FIG. 7 illustrates system-generated data.

FIG. 8 illustrates input data.

FIG. 9 illustrates determinative data.

FIG. 10 illustrates non-determinative data.

FIGS. 11A and 11B illustrate a first citation.

FIG. 12 illustrates a second citation.

FIG. 13 illustrates data flow between a mobile citation device and a server.

FIG. 14 illustrates a preferred method for generating one or more citations from a single workflow.

### DETAILED DESCRIPTION

Described herein is a system and method for generating one or more citation types from a single workflow. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), numerous programming decisions must be made to achieve the developers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of database design and management having the benefit of this disclosure. Accordingly, the claims appended hereto are not intended to be limited by the disclosed embodiments, but are to be accorded their widest scope consistent with the principles and features disclosed herein.

FIG. 1 illustrates a citation management system 100. Citation management system 100 can comprise a mobile citation device 101 that can capture citation data at or near the location of a violation. Within citation management system 100, there can exist many mobile citation devices 101, each associated with a different citation officer. Mobile citation device 101 can connect to a printer 102. Mobile citation device 101 can also connect to a network 103, which can connect to a server 104. In one embodiment, as shown in FIG. 1, printer 102 can be hardwired to mobile citation device 101. In another embodiment, printer 102 can connect to mobile citation device 101 via a localized network, such as a piconet. In another embodiment, printer 102 can be a component of mobile citation device 101. Network 103 can be a local area network (LAN), a wide area network (WAN), a piconet, or a combination of LANs, WANs, or piconets. One illustrative LAN is a network within a single business. One illustrative WAN is the Internet. Server 104 represents at least one, but can be many servers, each connected to network 103. Server 104 can connect to a storage device 105. Storage device 105 can connect directly to server 104, as shown in FIG. 1, or may exist remotely on network 103. Storage device 105 can comprise any suitable long-term or persistent storage device and, further, may be separate devices or the same device and may be collocated or distributed (interconnected via any suitable communications network). Citation management system 100 can also include one or more computers 106, connected to the network 103. Computer 106 can include, but is not limited to, a laptop, desktop, workstation, server, mainframe, terminal, and/or mobile citation device 101.

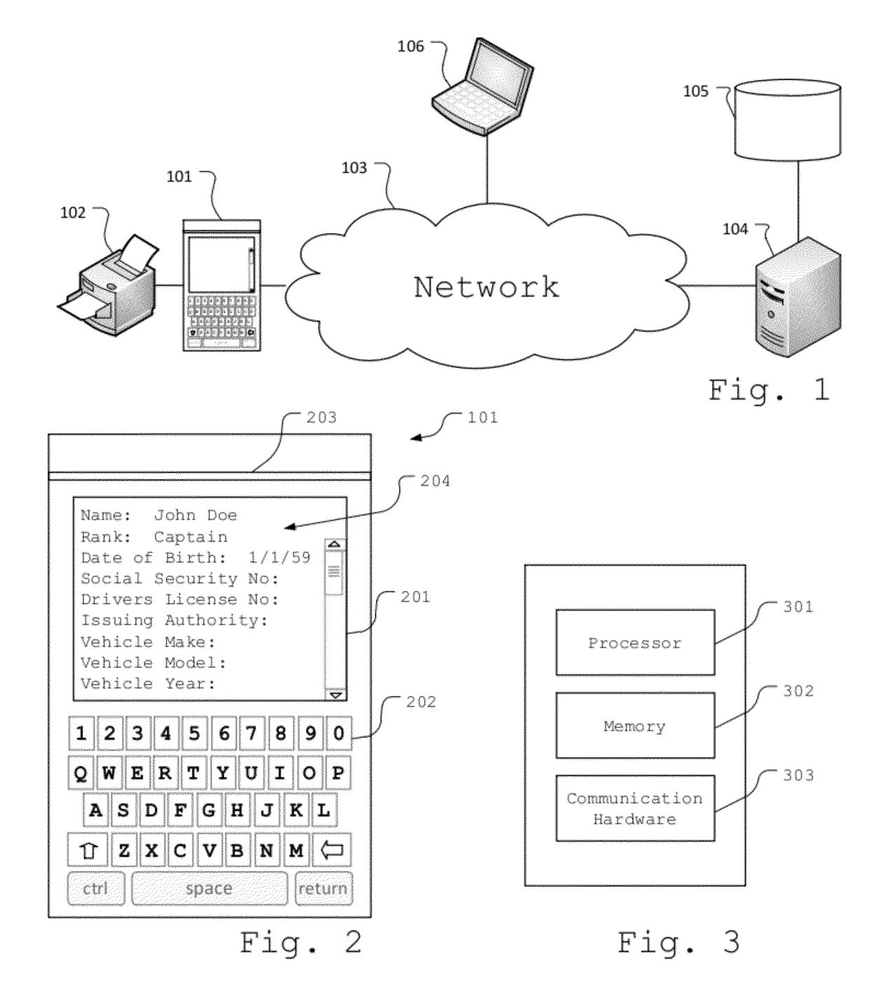

FIG. 2 illustrates input and output hardware on mobile citation device 101. Mobile citation device 101 can include, but is not limited to, a screen 201, a keypad 202, and a card reader 203. Other input devices can include track balls, joy sticks, or scroll wheels. Input data 204 can include a violator's name, offenses, military rank, serial number, grade, military organization, military installation, and/or an identity of a Supervisor. Keypad 202 can comprise a plurality of physical buttons on mobile citation device 101, however, in an embodiment where screen 201 is a touch screen, keypad 202 can be represented virtually on screen 201. Card reader 203 can read information from an identification card. An identification card can encode information in various ways. Information can be printed on the information card. Also, information can be placed on the card in a machine-readable form. Such forms can include magnetic strip, barcode, or even radio frequency identification (RFID) chip. An identification card can include, but is not limited to, a civilian or military driver's license, a passport, a school identification badge, or a credit card. In one embodiment, card reader 203 can read a magnetic strip on an identification card. In another embodiment, card reader 203 can read information encoded in a barcode on an identification card. In another embodiment, card reader 203 comprises a (RFID) chip receiver to read an RFID chip in an identification card.

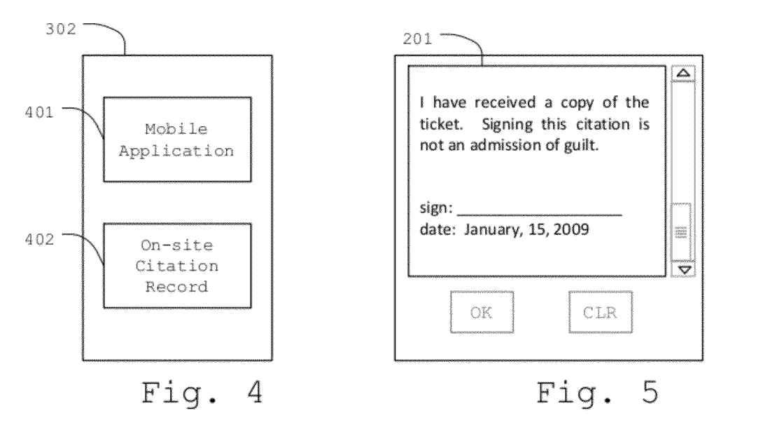

FIG. 3 illustrates internal hardware within mobile citation device 101. Input data 204 from screen 201, keypad 202, and/or card reader 203 is sent to a processor 301. Processor 301 can perform processes on the data according to an application stored in a memory 302, as discussed further below. Processes can include storing input data 204 to memory 302, verifying input data 204 conforms to preset standards, or ensuring all required data has been gathered for a citation to be complete. For purposes of this disclosure, input data 204 can include data which mobile citation device 101 may populate automatically, such as date and time, as well as data entered manually. Communication hardware 303 can include a network transport processor for packetizing data, communication ports for wired communication, or an antenna for wireless communication.

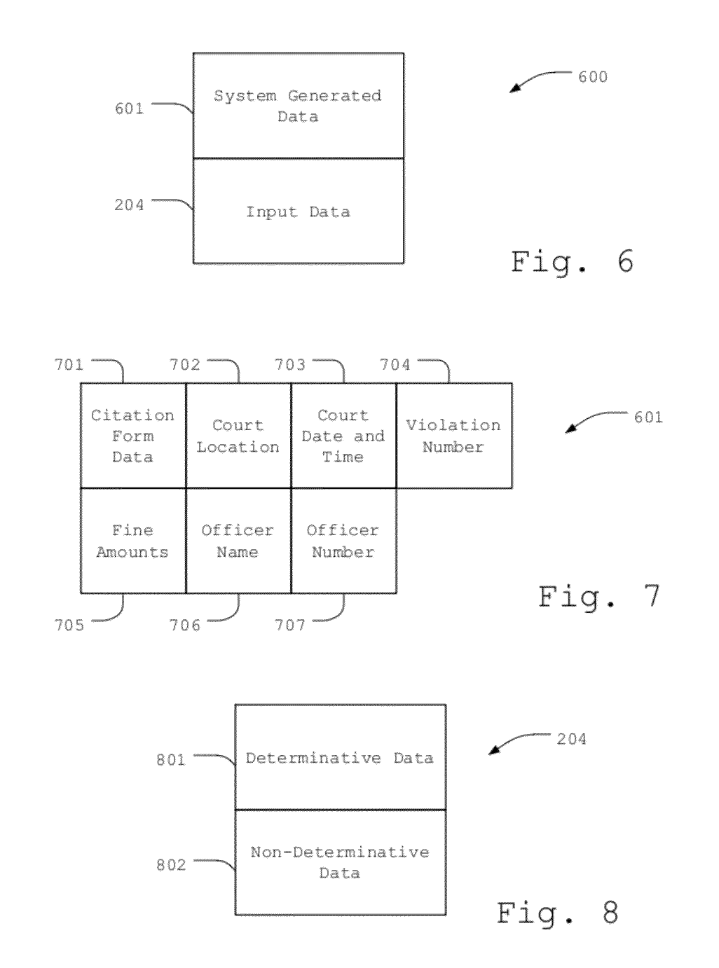

FIG. 4 illustrates a memory map of memory 302. Users with mobile citation device 101 can capture input data 204. Executing a mobile application 401, stored in memory 302, mobile citation device 101 can display a series of data input fields capable of accepting input data 204 from the users. Further, mobile application 401 can display input data 204 to screen, store input data 204 in memory 302, and/or transmit input data 204 to server 104. Further, in one embodiment, mobile application 401 can process at least a portion of input data 204 to form an on-site citation record 402. In such embodiment, on-site citation record 402 can be sent to communication hardware 303 for communication over network 103 to server 104. In one embodiment, mobile application 401 can be a browser application. Further, mobile application 401 can be used to access a web-based application, as described below.

FIG. 5 illustrates a screen shot of mobile citation device 101. Screen 201 can be a mere display output, or can also be a touch screen, allowing for capturing of input data 204. In some jurisdictions, it may be necessary to obtain a signature from a violator. In one embodiment, screen 201 can be used as an input device using a stylus. Using the stylus, a violator can sign his name on screen 201. Screen 201 can then capture the signature as an image to store with other citation data.

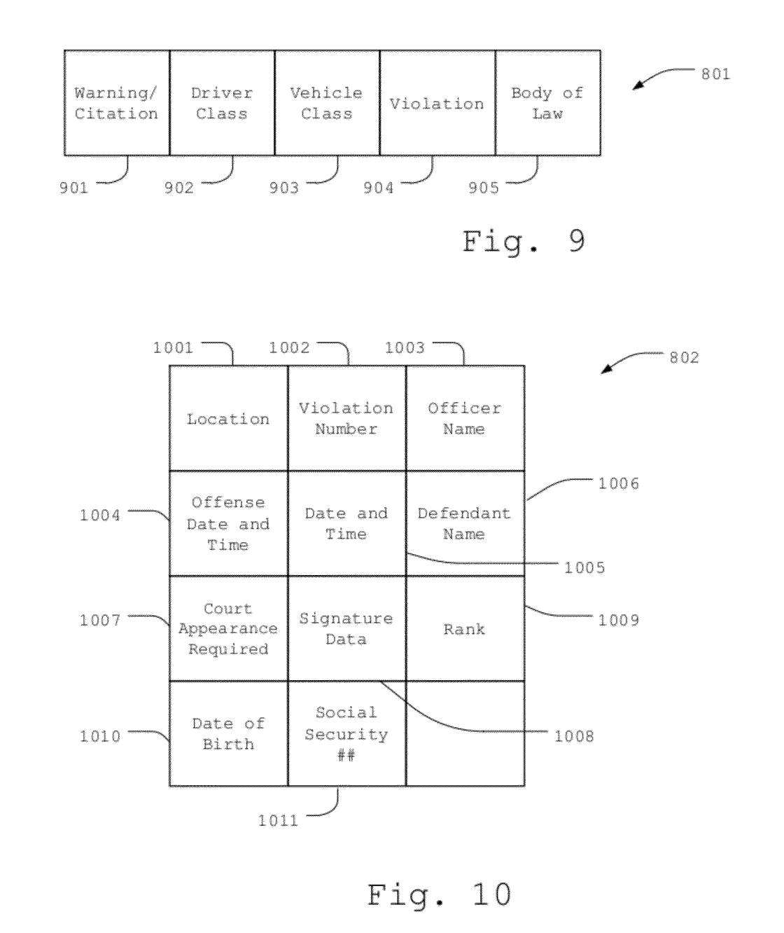

FIG. 6 illustrates data 600. Data 600 can comprise system-generated data 601 and input data 204.

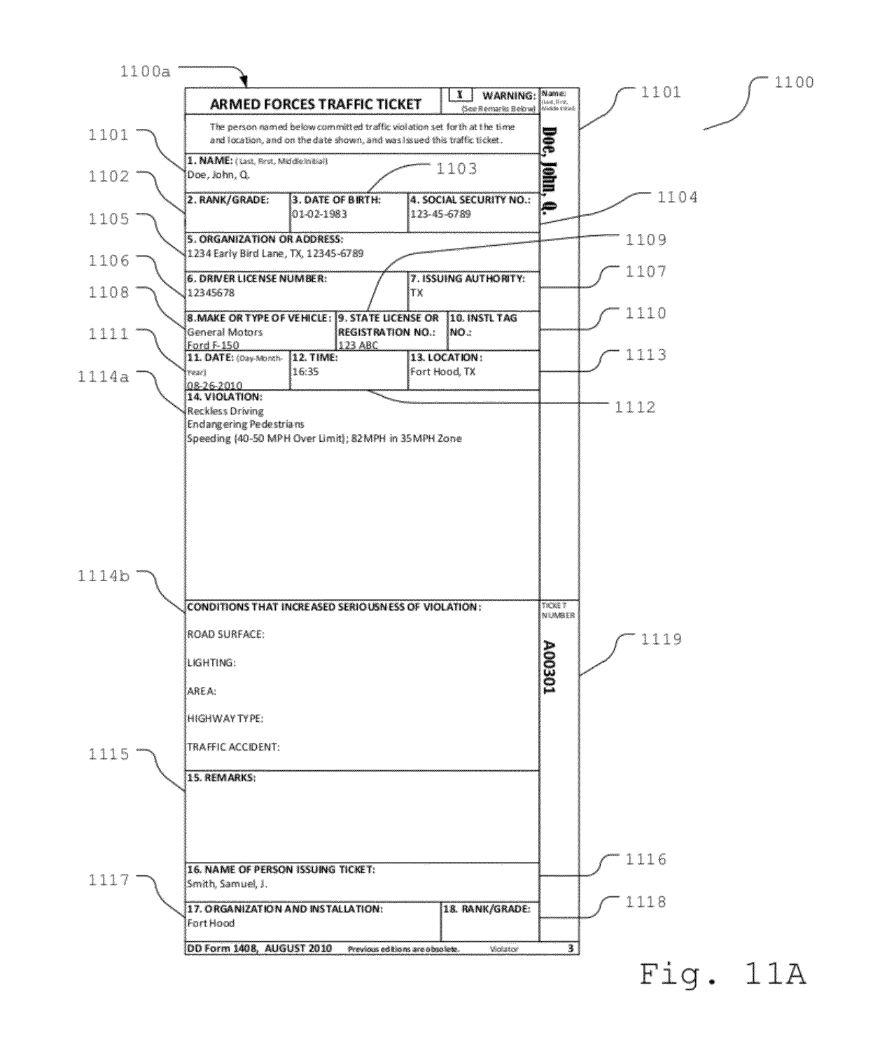

FIG. 7 illustrates system-generated data 601. System-generated data 601 can comprise citation form data 701, a court location field 702, a court date and time field 703, a violation number 704, fine amounts data 705, an officer name field 706, and an officer number 707.

FIG. 8 illustrates input data 204. Input data 204 can comprise determinative data 801 and non-determinative data 802. Determinative data 801 can be used to determine what citation form to issue; e.g., an Armed Forces Traffic Ticket form, a United States District Court Violation Notice form, both, or some other type of citation form. For example, where a citation officer wishes to issue a warning, a field within the input data 204 designating that a warning has been issued would be determinative data 801 since that choice is determinative in the choice to issue a an Armed Forces Traffic Ticket form.

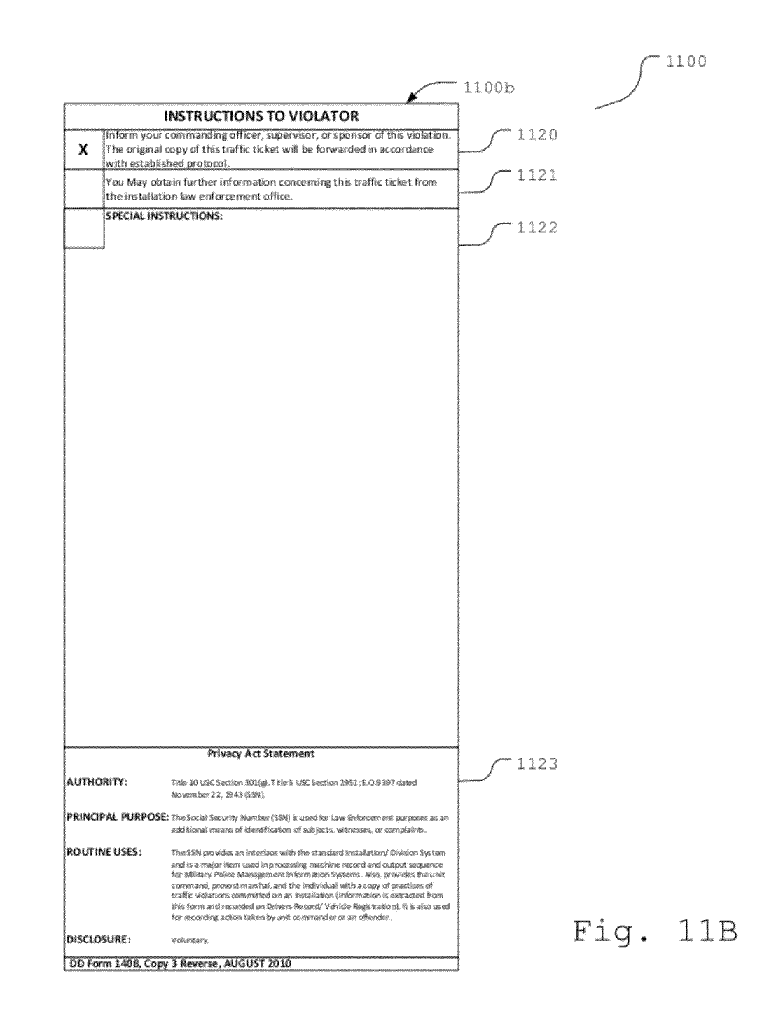

FIG. 9 illustrates determinative data. Determinative data 801 can comprise a warning/citation field 901, a driver class field 902, a vehicle class field 903, violation data 904, and body of law data 905.

FIG. 10 illustrates non-determinative data 802. Non-determinative data 802 can comprise location data 1001, one or more violation numbers 1002, an officer name 1003, an offense date and time 1004, date and time data 1005, a defendant name field 1006, a court appearance requirement field 1007, signature data 1008, a rank field 1009, a date of birth field 1010, and a social security number field 1011.

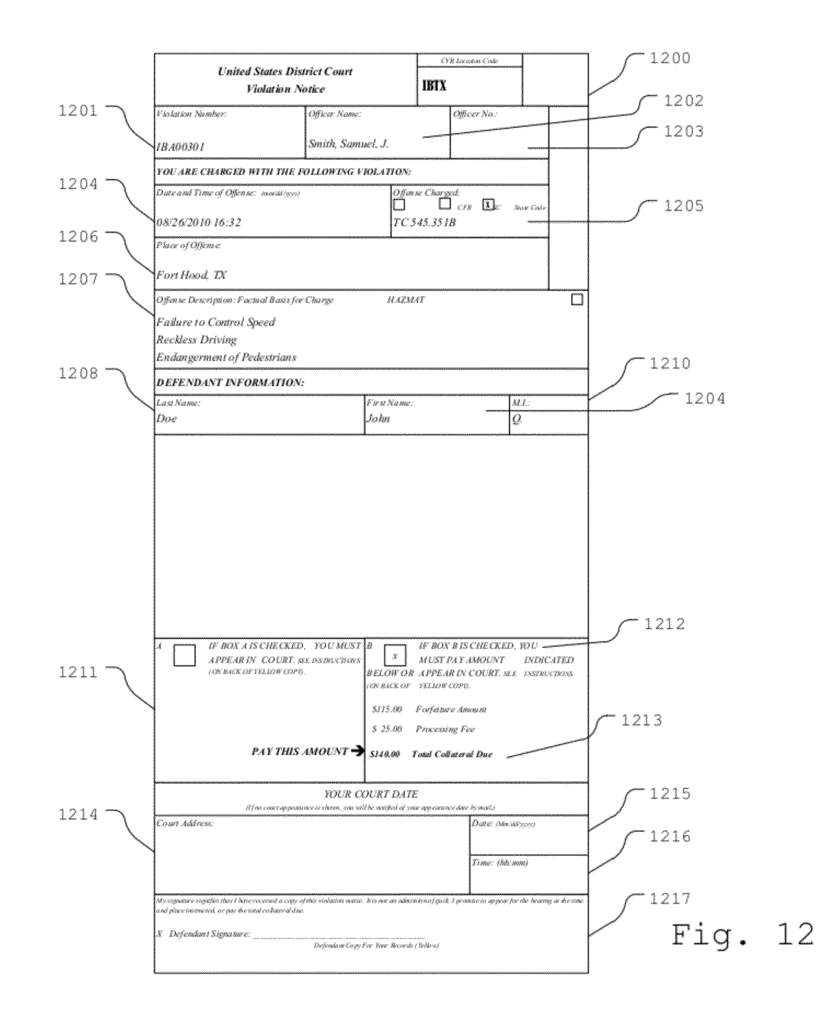

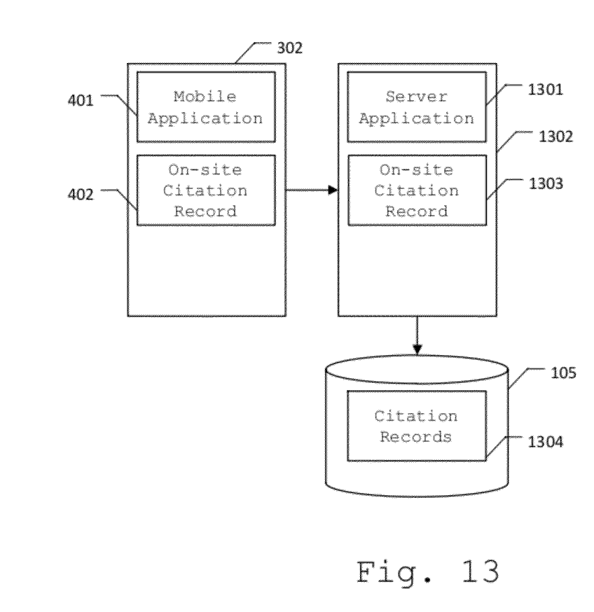

FIGS. 11A and 11B illustrate a first citation 1100. The first citation 1100 can comprise a first portion 1100a and a second portion 1100b.

FIG. 11A illustrates the first portion 1100a and FIG. 11B illustrates the second portion 1100b. In one embodiment, the first portion 1100a can be a first side of the first citation 1100 and the second portion 1100b can be a second side of the first citation 1100. In another embodiment, the first portion 1100a and the second portion 1100b can be two separate pieces of paper. The first citation 1100 can comprise several fields including a name field 1101, a rank field 1102, a date of birth field 1103, a social security number field 1104, an organization/address field 1105, a driver license number field 1106, an issuing authority field 1107, a vehicle make field 1108, a state license/registration authority field 1109, a tag number field 1110, a date of offense 1111, a time field 1112, a location field 1113, a violations field 1114a, a seriousness factors field 1114b, a remarks field 1115, an issuing person field 1116, an organization/installation field 1117, a rank-grade field 1118, a ticket number field 1119, an inform Supervisor field 1120, a further information directive field 1121, and a special instructions field 1122. In one embodiment, the fields are distributed between the first portion 1100a and the second portion 1100b, as necessary, to ensure both portions are readable. In another embodiment, portions of on-site citation record 402 can correspond to the fields on the first citation 1100. In such embodiment, portions of on-site citation record 402 are printed on the first citation 1100 and the first citation 1100 can be mailed, handed to, or faxed to recipients preferring paper to electronic records. For example, in one embodiment, a paper citation such as the first citation 1100 can be handed to the violator and his commanding officer.

FIG. 12 illustrates a second citation 1200. Second citation 1200 can comprise several fields including a violation number field 1201, an officer name field 1202, an officer number field 1203, a date and time of offense field 1204, one or more offense charged selection boxes 1205, a place of offense field 1206, offense description and factual basis for charge data 1207, a defendant last name field 1208, defendant first name field 1209, defendant middle initial field 1210, a court appearance requirement field 1211, a payment requirement field 1212, invoice data 1213, a court address field 1214, a court date field 1215, a court time field 1216, and a defendant signature field 1217. In one embodiment, portions of on-site citation record 402 can correspond to the fields on the second citation 1200. In such embodiment, portions of on-site citation record 402 are printed on the second citation 1200 which can be mailed, handed to, or faxed to recipients preferring paper to electronic records. For example, in one embodiment, a paper citation such as the second citation 1200 can be handed to the violator and his commanding officer. In another embodiment, all or portions of on-site citation records 402 associated with citation 1100 and or citation 1200 can be delivered in electronic form to a central violations bureau or other citation processing entity.

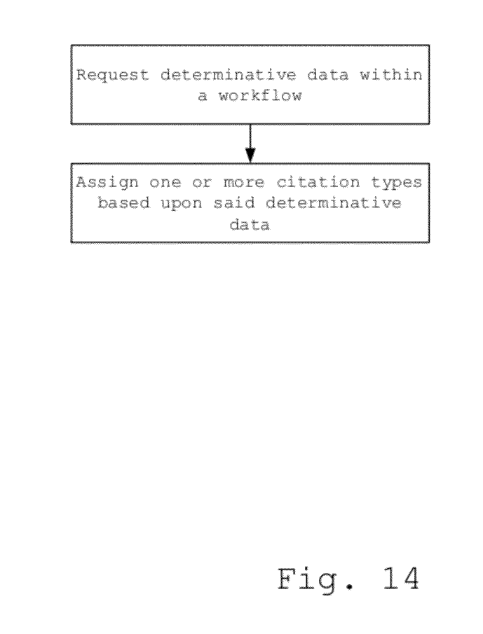

FIG. 13 illustrates data flow between a mobile citation device and a server. A citation officer, using mobile citation device 101, can capture input data 204. Executing a mobile device application 401 stored in memory 302, mobile citation device 101 can display a series of data input fields capable of accepting input data 204 from the citation officer. Further, mobile device application 401 can display input data 204 to screen, store input data 204 in memory 302, and/or transmit input data 204 to server 104. Further, in one embodiment, mobile device application 401 can process at least a portion of input data 204 to form an on-site citation record 402. In such embodiment, on-site citation record 402 can be sent to server 104. At least a portion of input data 204 can be sent to server 104 where a server application 1301 can exist in a server address space 1302. In one embodiment, server application 1301 can form on-site citation record 1303. On-site records can be distinguished using unique identifiers, which are described in patent application Ser. No. 12/648,850, titled Electronic Citation Recording, Processing and Storing, which is hereby incorporated by reference. Server application 1301 can perform various tasks including verifying that on-site citation record 1303 is complete, storing on-site citation record 1303 in a citation record 1304 in storage device 105. In one embodiment, server application 1301 is a web-based application capable of being accessed by users on network 104. Further, in another embodiment, server application 1301 can issue multiple citation types in a singular workflow based upon determinative data 801. For example, in one embodiment, the citation officer can issue a warning on an Armed Forces Traffic Ticket without shifting from a workflow for issuing a citation on a United States District Court Violation Notice form.

FIG. 14 illustrates an exemplary method for generating one or more citations from a single workflow. First, determinative data 801 is requested within a workflow. Further, determinative data 801 is assigned one or more citation forms based upon said determinative data 801. In one embodiment, non-determinative data 802 can be requested related to one or more citation forms.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for generating one or more citation forms from a single workflow, comprising
requesting determinative data within a workflow, and
generating one or more citation forms based upon said determinative data.

2. The method of claim 1 wherein generating one or more citation forms based upon said determinative data comprises the step of requesting non-determinative data related to the one or more citation forms.

3. The method of claim 1 wherein the workflow is related to issuance of a citation on a United States District Court Violation Notice form.

4. The method of claim 1 wherein the determinative data is comprises data related to issuance of a warning for a code infraction to be issued on one of the one or more citation forms.

5. The method of claim 4 wherein said warning is to be issued on a federal or military installation.

6. The method of claim 5 wherein the warning is issued on an Armed Forces Traffic Ticket form.

7. The method of claim 6 wherein a second citation is issued on a United States District Court Violation Notice form.

8. The method of claim 1 wherein the determinative data comprises data related to the military status of a violator.

9. The method of claim 1 wherein the determinative data comprises data related to military or federal ownership of a vehicle.

10. A system for generating one or more citation forms from a single workflow, comprising
a mobile citation device that
requests and receives determinative data within a workflow, and
requests non-determinative data relating to one or more citation forms based upon said determinative data.

11. The system of claim 10 further comprising
a server that comprises a server application in an address space; and
a network, wherein the mobile device transmits the determinative data over the network to the server, further wherein the server application sends a request for the non-determinative data over the network to the mobile citation device.

12. The system of claim 10 wherein the determinative data comprises data related to issuance of a warning for a code infraction

13. The system of claim 12 wherein said warning is issued on a federal or military installation.

14. The system of claim 13 wherein said warning is issued on an Armed Forces Traffic Ticket form.

15. The system of claim 14 wherein a second citation is issued on a United States District Court Violation Notice form.

16. The system of claim 10 wherein the determinative data comprises data related to military status of a violator.

17. The system of claim 10 wherein the determinative data comprises data related to military or federal ownership of a vehicle.

18. The system of claim 11 wherein the mobile citation device comprises a mobile application capable of communicating with the server application.

19. The system of claim 18 wherein the mobile application is a browser application.

20. A computer usable medium having a computer readable program code embodied therein, wherein the computer readable program code is adapted to be executed to implement the method of claim 1.
